(19) United States
(12) Patent Application Publication
(10) Pub. No.: US 2019/0241379 A1
(43) Pub. Date: Aug. 8, 2019

(54) METHOD FOR TRANSFERRING STANDARDISED CONTAINERS BETWEEN A CONTAINER SHIP AND A QUAY

(71) Applicant: Antonio Marcos RUIZ VEGA, El Puerto de Santa María (ES)

(72) Inventor: Antonio Marcos RUIZ VEGA, El Puerto de Santa María (ES)

(21) Appl. No.: 16/067,956

(22) PCT Filed: Dec. 31, 2016
(86) PCT No.: PCT/ES2016/070953

§ 371 Date: Jul. 3, 2018

(30) Foreign Application Priority Data
Jan. 6, 2016 (ES) P201630005

(51) Int. Cl. B65G 63/00; B66C 17/20; B66C 19/00; B63B 25/28; B63B 11/02

(52) U.S. Cl. CPC B65G 63/004; B66C 17/20; B63B 11/02; B63B 25/28; B66C 19/002

(57) ABSTRACT

Method for transferring standardized containers between a container ship and a quay, using harbor cranes such as a gantry crane, wherein during the entire maneuver, the longitudinal axes of the containers are perpendicular to the edge of the quay. In order to carry out said method, two items are used: a container ship where the standardized containers are arranged with the longitudinal axes thereof orthogonal to the longitudinal axis of the ship, and a harbor crane such as a gantry crane used to transfer standardized containers in a position such that the longitudinal axes thereof are orthogonal to the edge of the quay; this allows the gap between legs of the crane to be smaller than that of current cranes as said gap depends on the arrangement of the container as it passes therethrough; thus, a higher number of cranes can operate on the same ship of the same length.

### FIELD OF THE INVENTION

The present invention belongs to the sector of terrestrial maritime transport through the use of containers and more specifically to the transfer or transship to storage areas, to freight stations or to harbors (B65G 63/00).

The main object of the present invention is a method for transferring standardized containers between a container ship and a quay, through the use of harbor cranes such as a gantry crane, characterized in that during the entire maneuver the longitudinal axes of the containers are perpendicular to the edge of the quay.

To carry out this method, two inventions closely related thereto are required: a container ship where the standardized containers arranged with the longitudinal axes thereof orthogonal to the longitudinal axis of the ship (B63B 11/00; B63B 25/00) and a harbor crane such as a gantry crane capable of transferring standardized containers in a position such that the longitudinal axes thereof are orthogonal to the edge of the quay (B66C 19/00; B66C 17/00); this allows the gap between its legs to be smaller than that of the current cranes as said gap depends on the arrangement of the container as it passes therethrough; in this way a higher number of cranes can operate on the same ship of the same length, improving the loading/unloading performances.

### BACKGROUND

The maritime transport of goods in containers of standardized dimensions has experienced a great growth in the last fifteen years due to the ease of combination with other types of transport (by railroad, by road), to the high efficiency of loading and unloading the container ship within the harbor and to the gradual automation of the operations in the terminal of containers itself that allows to optimize the movements of the standardized containers within it.

In line with that great growth, the container ship fleet has increased both in number and size of said ships; likewise, the size and range of the harbor cranes such as a gantry crane that carry out the loading and unloading of the container ships has been increasing in parallel with them and with the increasing demands required.

Within a terminal of containers the loading and unloading of these between the container ship and the terminal is conducted by means of harbor cranes such as a gantry crane over rails located in the terminal itself, harbor cranes that move along the full length of the quay; the transfer of the standardized containers from the operation area of these harbor cranes to the rear storage esplanade (patio), is generally conducted by trucks or mobile gantries; inside that rear storage esplanade the transfer of containers is conducted in a manual (by means of trolleys) semiautomatic or automatic way.

All the operations of the loading and unloading of standardized containers and the dimensions of the equipment used for this purpose are fixed, amongst other factors, by the arrangement of the standardized containers in the container ships; this arrangement is widespread in the current container ships and is such that the longitudinal axes of the standardized containers are parallel to the longitudinal axis of the container ship. Therefore, the harbor cranes such as a gantry crane are geometrically dimensioned for the loading and unloading of these standardized containers for that arrangement in the container ship; for that reason, the gap between the legs over a same rail of these harbor cranes depends on the length of the standardized containers that have to be moved passing between them plus a margin of safety on each side between each leg and the standardized container.

Harbor cranes capable of handling several standardized containers at the same time with strict separation between them but always with their longitudinal axes parallel to the quay have been developed (in EP0318264 A1 a crane with these characteristics is described)

The unloading in the transport vehicles is normally carried out also in that arrangement although there are patents that consider a turn of the standardized container of 90° until it is positioned with its longitudinal axis perpendicular to the quay, turn conducted with devices incorporated or close to the cranes (in ES 2498916 T3 it is described a gantry crane with double trolley that conducts this maneuver and in ES 2336818 T3 it is described a process of loading/unloading of containers that includes the turn of them in a device close to the cranes).

### SUMMARY OF THE INVENTION

The object of the invention is to improve the loading/unloading performances of standardized containers between a container ship and the quay of a harbor terminal and, also, to obtain a better use of the length of said quay.

Specifically, it is a method for transferring (loading/unloading) standardized containers from a container ship to the quay and conversely, by the use of harbor cranes such as a gantry crane, which is characterized because during the entire maneuver the standardized containers are positioned with the longitudinal axes thereof perpendicular to the quay; for this and unlike the current ships, the standardized containers must be arranged in the container ship with the longitudinal axes thereof orthogonal to the longitudinal axis of the ship; the harbor cranes such as a gantry crane, in turn, must have capacity to maneuver the standardized containers in that position. With this arrangement of the standardized containers the width of the cranes can decrease as this depends on the width of the standardized container that must pass between its legs (8 feet) and not on the length of the same (20 or 40 feet), as in the current cranes; this allows a higher number of cranes operating in the same ship at equal length, which effects a shorter time for the total loading/unloading and, moreover, allows the better use of the length of the quay of the terminal.

To carry out this method two new inventions closely related thereto are required; on the one hand, a container ship with the standardized containers arranged with the longitudinal axes thereof orthogonal to the longitudinal axis of the ship and, on the other, a harbor crane such as a gantry crane capable of transferring standardized containers to a position such that the longitudinal axes thereof are orthogonal to the edge of the quay which allows the gap between legs to be noticeably smaller than the gap of the current cranes since, as has been indicated, said gap depends on the arrangement of the standardized container as it passes therethrough.

The first invention closely related to the method is a container ship that is characterized because the standardized containers are arranged with the longitudinal axes thereof orthogonal to the longitudinal axis of the ship both in the holds and outside of them; for it, the holds where they are stored are formed by transverse bulkheads orthogonal to the longitudinal axis of the ship, bulkheads that contribute to the resistance of the same, with a separation between these transverse bulkheads such as to allow the placement of a whole number of standardized containers arranged transversely; moreover, each one of these holds between transverse bulkheads in turn is subdivided by longitudinal secondary bulkheads separated from each other by the length of a standardized container plus the necessary clearances; in these longitudinal secondary bulkheads and on the inside of the sides of the hull that close the hold vertical guides are installed so as to allow to arrange the placement of the standardized containers stacked with the longitudinal axes thereof perpendicular to the longitudinal axis of the ship. These vertical guides can be extended outside the holds and above them, installing them on longitudinal frames of suitable rigidity in vertical extension of the longitudinal secondary bulkheads and of the sides of the hull, longitudinal frames that with the help of closing transverse frames of suitable rigidity in vertical extension of the transverse bulkheads constitute a cellular structure, exterior to the holds, where standardized containers can be arranged in the thus formed cells with the same arrangement as those located in said holds.

The second invention closely related to the method is a harbor crane such as a gantry crane for loading and unloading of standardized containers that is supported by four legs with rolling mechanisms (sets of support wheels), two front on a front rail and two rear on a rear rail, allowing the movement along the quay; this crane has a jib perpendicular to the quay located in the gap formed between the legs and that is supported by the gantry, jib that supports a carriage that moves longitudinally under it and from which hangs in turn by means of cables a container clamping mechanism (spreader) equipped with vertical movement, according to needs, thanks to lifting and lowering means located on the carriage. The invention centers on that the spreader is arranged so that its longitudinal axis coincides with the longitudinal axis of the jib so that the standardized containers are loaded and unloaded with the longitudinal axes thereof perpendicular to the edge of the quay; this allows that the existing gap between legs on the same rail can be reduced adjusting it in such way that, without endangering the stability of the harbor crane, allows the passage between the legs of the width of a standardized container with the necessary clearances, for reasons of safety, logistics or of any other nature, between standardized container and legs.

The method of unloading of standardized containers from a container ship to the quay consists of the following steps:
Berthing of container ship with transversal arrangement of the standardized containers inside and outside the holds.
Positioning on the edge of the quay of a harbor crane such as a gantry crane with capacity to maneuver these standardized containers by means of a spreader whose longitudinal axis coincides in direction with the longitudinal axis of the standardized containers (both axes orthogonal to the quay).
Forward movement of the carriage under the jib of the crane until being positioned on the standardized container to be moved, with the spreader elevated.
With the lifting and lowering means located on the carriage, maneuver of descent of the spreader until it is fixed and secured to the standardized container.
Maneuver of ascent of the spreader—standardized container set and subsequent backwards movement of the carriage under the jib, passing between the legs of the crane, until being positioned on the means of transport previously located under the crane in orthogonal position to the quay.
With the lifting and lowering means located on the carriage, maneuver of descent of the spreader—standardized container set until having the standardized container resting on the means of transport and fixed on the same; disconnection of the spreader fixings on the standardized container.
Maneuver of ascent of the empty spreader and forward movement of the carriage under the jib of the crane until it is positioned, with the spreader elevated, on a new standardized container to be transferred to start again the cycle.

The method of loading of standardized containers from the quay to a container ship consists of the following steps:
Berthing of container ship with transversal arrangement of the standardized containers inside and outside the holds.
Positioning on the edge of the quay of a harbor crane such as a gantry crane with capacity to maneuver these standardized containers by means of a spreader whose longitudinal axis coincides in direction with the longitudinal axis of the standardized containers (both axes orthogonal to the quay).
Positioning on the edge of the quay, under the crane and in orthogonal position to the quay of the means of transport with the standardized container to be loaded in the ship.
Movement of the carriage under the jib of the crane until being positioned on the means of transport—standardized container set, with the spreader elevated.
With the lifting and lowering means located on the carriage, maneuver of descent of the spreader until it is fixed and secured to the standardized container; release of the fixings of the standardized container with the means of transport.
Maneuver of ascent of the spreader—standardized container set and subsequent forward movement of the carriage under the jib, passing between the legs of the crane, until being positioned on the corresponding cell in the container ship.
With the lifting and lowering means located on the carriage, maneuver of descent of the spreader—standardized container set using the vertical guides of the ship until leaving the standardized container on its final position, already over another standardized container already placed, already on the bottom of the hold; subsequent disconnection of the spreader fixings on the standardized container and fastening of the standardized container on the ship with stowage elements.
Maneuver of ascent of the empty spreader and subsequent backwards movement of the carriage under the jib, passing between the legs of the crane, until it is positioned, with the spreader elevated, on a new means of transport—standardized container set to start again the cycle.

The current container ships can be adapted to this method; this is achieved by subdividing all or part of the holds formed by the existing transverse bulkheads by means of longitudinal secondary bulkheads separated from each other by the length of a standardized container plus the necessary clearances, by disassembling the existing vertical guides in the transverse bulkheads and installing vertical guides in the new longitudinal secondary bulkheads and on the inside of the sides of the hull so that standardized containers can be arranged in the thus formed cells with the longitudinal axes thereof perpendicular to the longitudinal axis of the ship. These new vertical guides can be extended outside the holds and above them, installing them on longitudinal frames of suitable rigidity in vertical extension of the longitudinal secondary bulkheads and of the sides of the hull, longitudinal frames that with the help of closing transverse frames of suitable rigidity in vertical extension of the transverse bulkheads constitute a cellular structure, exterior to the holds, where standardized containers can be arranged in the thus formed cells with the same arrangement as those located in said holds. These last transverse frames can be achieved by adapting the ones the ship generally has, frames from which the vertical guides will have to be disassembled.

This method can also be applied to container ships with transversal arrangement of the standardized containers implemented and in which for the stowage of said standardized containers, already in all or in part of the loading areas of the ship, vertical guides are not used but, in those areas without guides, the stowage is done by lashing.

Generalizing, this method can be applied to any merchant ship in general characterized because all or part of its holds and/or of the outer areas on them are adjusted for the stowage of standardized containers arranged with the longitudinal axes thereof orthogonal to the longitudinal axis of the ship.

As for cranes, this method can be applied to harbor cranes such as a gantry crane whose frame results from the composition of two or more individual frames, being supported by three or more pairs of legs with rolling mechanisms, three or more front legs on a front rail and three or more rear legs on a rear rail, allowing the movement along the quay; the total width of these composite cranes must be such as to allow the placement of two or more independent jibs perpendicular to the quay, supported by the gantry and located in the two or more gaps formed between the legs; each one of these jibs supports a carriage that moves longitudinally under it and from which hangs in turn a container clamping mechanism (spreader) equipped with vertical movement, according to needs, thanks to lifting and lowering means located on the carriage and that, just as the individual cranes, is arranged such that its longitudinal axis coincides with the longitudinal axis of the jib so that the standardized containers are loaded and unloaded with the longitudinal axes thereof perpendicular to the edge of the quay.

This method can also be applied to harbor cranes such as a gantry crane whose frame is supported by four legs with rolling mechanisms, two front on a front rail and two rear on a rear rail, allowing the movement along the quay, and whose characteristic is that the gap between legs of the same rail is such as to allow the placement of two or more independent jibs perpendicular to the quay, supported by the gantry and located in the gap formed between the legs; each one of these jibs, supports a carriage that moves longitudinally under it and from which hangs in turn a container clamping mechanism (spreader) equipped with vertical movement, according to needs, thanks to lifting and lowering means located on the carriage and that, just as the individual cranes, is arranged such that its longitudinal axis coincides with the longitudinal axis of the jib so that the standardized containers are loaded and unloaded with the longitudinal axes thereof perpendicular to the edge of the quay; the former allows that the current gap between legs on the same rail can be reduced adjusting it in such way that, without endangering the stability of the harbor crane and optimizing as much as possible that adjustment with regard to minimizing the movement of the crane along the quay in the loading and unloading operations, allows the passage between the width between the legs of two or more standardized containers with the necessary clearances, either for reasons of safety, logistics or of any other nature, between standardized container—standardized container and between standardized container —leg.

The described in the previous paragraph harbor cranes such as a gantry crane can have a variant that consists in that the two or more independent jibs are replaced by a single jib or a smaller number (divisor normally) of them perpendicular to the quay, supported by the gantry and located in the gap formed between the legs, jib/s of a suitable width to allow the support of two, three or more carriages independent with each other and that move longitudinally under it; from each one of the carriages hangs in turn a container clamping mechanism (spreader) equipped with vertical movement, according to needs, thanks to lifting and lowering means located on the carriage, spreader arranged such that its longitudinal axis coincides with the longitudinal axis of the jib so that the standardized containers are loaded and unloaded with the longitudinal axes thereof perpendicular to the edge of the quay.

In addition, this method can be applied to harbor cranes such as a gantry crane resulting from the composition of two or more harbor cranes of the ones described in the two previous paragraphs, the set being supported by three or more pairs of legs with rolling mechanisms, three or more front legs on a front rail and three or more rear legs on a rear rail, allowing the movement along the quay; the total width of these composite cranes must be such as to allow the placement of two or more groups of two or more independent jibs each, or two or more groups of a single jib or of a smaller number (divisor normally) of the number of independent jibs, with two, three or more carriages independent with each other under them; these jibs are all perpendicular to the quay, supported by the gantry and located in the two or more gaps formed between the legs, jibs that support carriages that move longitudinally under them and from each one of them hangs in turn a container clamping mechanism (spreader) equipped with vertical movement, according to needs, thanks to lifting and lowering means located on the carriage, spreader arranged such that its longitudinal axis coincides with the longitudinal axis of the jib so that the standardized containers are loaded and unloaded with the longitudinal axes thereof perpendicular to the edge of the quay.

Also, this method can be applied to harbor cranes such as a gantry crane in which the gaps between standardized container—standardized container are non-existent, which allows to operate with standardized containers adjacent to the ship provided that the crossing at the level between them is avoided, both vertically and horizontally, during the loading-unloading operations.

When applying the method to the previously described harbor cranes such as a gantry crane, the rear legs of these can hinder, to a greater or lesser extent, the passage between them of the transport means of standardized containers when these move from the storage area until the loading/unloading area located under the cranes and, likewise, can hinder the positioning maneuvers for these operations; this can occur, above all, with the harbor cranes of a single jib of a single carriage by gap. By means of a loading beam all along the line of the rear rail, elevated by pillars of a sufficient height to allow the passage of the transport means under it, pillars that go to foundation, and with a spacing between said pillars that is considerably greater than the gap between legs of crane, a more clear crossing area can be obtained and, therefore, that facilitates the passage and the maneuvers of the transport means; on that loading beam the rear rail is fixed, on that elevated rail the rear legs of the cranes with their rolling mechanisms are rested, legs that, for that reason, are shorter than the front legs.

The method can be applied to the loading/unloading in a single cycle of two or more standardized containers contiguous in width (with the long sides adjacent) by multiple spreaders capable to maneuver all at once that number of standardized containers. In the case of a double spreader, this is of an identical length to the simple spreaders but twice as wide; the longitudinal axis of this double spreader is, the one of the simple spreaders, coinciding with the longitudinal axis of the jib that supports the carriage that maneuvers it. This disposition applies to the previously described harbor cranes such as a gantry crane, with one or several independent jibs or with one or several jibs with one or more independent carriages from each one of which hang double spreaders, always taking into account the necessary clearances, either for reasons of safety, logistics or of any other nature, between containers of contiguous double spreaders and between container—leg of the crane and optimizing as much as possible these clearances with regard to minimizing the movement of the crane along the quay in the operations of loading and unloading. In the case of spreaders to maneuver three or more containers the reasoning is equivalent. The means of transport to be positioned under the crane must have adequate dimensions to be able to move two or more standardized containers all at once.

The method for loading and unloading of standardized containers to be applied to the previously described harbor cranes such as a gantry crane can have a variant characterized in that an intermediate step exists by which the standardized container is unloaded on an independent frame (or loaded from that frame, in the inverse operation) located under the crane, instead of being directly unloaded on the means of transport (or loaded from that means of transport, in the inverse operation); this lower frame, that may or may not be attached to the harbor crane, is served by one or more independent with each other and parallel to the quay bridge cranes; these bridge cranes are on two supports on lower horizontal beams perpendicular to the quay, beams that are each connected at their ends to the two lower horizontal beams of the frame of the harbor crane that are parallel to the quay; these bridge cranes move orthogonally to the quay each with a lower carriage, attached to it, equipped with another spreader which in turn is coupled, by fixing it, to the standardized container located in the lower frame to move it and load it (or unload it in the inverse operation) in the means of transport of standardized containers; with this the typical cycle of the harbor crane such as a gantry crane is simplified.

### BRIEF DESCRIPTION OF THE DRAWINGS

To complement the description that is being made and in order to help for a better understanding of the characteristics of the invention, it is included as an integral part of said description a set of drawings in which, with illustrative and not limiting character, the following has been presented:

FIGS. 1a and 1b.—They show in plan, elevation and cross section the difference between the arrangement of standardized containers in a current container ship (1a) and a container ship according to the first invention related to the method (1b)

FIG. 1c.—It shows in plan and elevation a container ship according to the first invention related to the method with bays of 6 rows (1c).

FIG. 2.—It shows in plan a detail of the front area of the container ship according to the first invention related to the process.

FIG. 3.—It shows the longitudinal and transversal elevations of the harbor crane such as a gantry crane, according to the second invention related to the method, with which the transfer method of standardized containers will be presented.

FIGS. 4a and 4b.—They show, respectively, longitudinal and transversal elevations of the set quay, container ship with bays of 8 rows and harbor cranes such as a gantry crane of single jib with two independent carriages.

FIGS. 5a and 5b.—They show, respectively, longitudinal elevations of a container ship with bays of 6 rows and harbor cranes such as a gantry crane of single jib with three independent carriages and of a container ship with bays of 6 rows and harbor cranes such as a gantry crane of single jib with two independent carriages.

FIGS. 6a, 6b, 6c, 6d and 6e.—They show longitudinal elevations of some of the different embodiments of harbor cranes such as a gantry crane according to the second invention related to the method and with which the same can be performed.

(1) Standardized container

(1a) Current container ship with longitudinal arrangement of standardized containers

(1b) Container ship with transversal arrangement of standardized containers and bays of 5 rows

(1c) Container ship with transversal arrangement of standardized containers and bays of 6 rows

(1d) Container ship with transversal arrangement of standardized containers and bays of 8 rows

(2) Bay or hold

(3) Transverse bulkhead

(4) Secondary longitudinal bulkhead

(5) Side of the hull

(6) Vertical guide

(7a) Harbor crane of two independent jibs with a carriage each

(7b) Harbor crane of singe jib with two independent carriages

(7c) Harbor crane of single jib with three independent carriages

(8) Independent jib

(9) Single jib

(10) Carriage

(11) Frame

(12) Rail

(13) Front legs

(14) Rear legs

(15) Standardized container clamping mechanism (spreader)

(16) Quay

(17) Means of transport

(18) Lower frame

(19) Bridge crane

(20) Lower horizontal beam perpendicular to the quay

(21) Lower horizontal beam of the frame of the harbor crane that is parallel to the quay

(22) Lower carriage

### Best Way to Carry Out the Invention

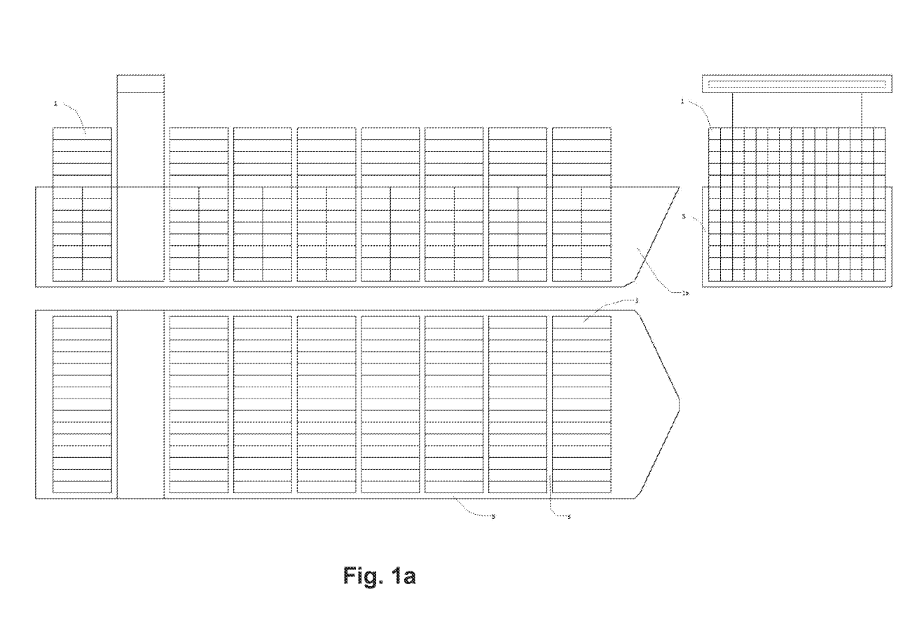

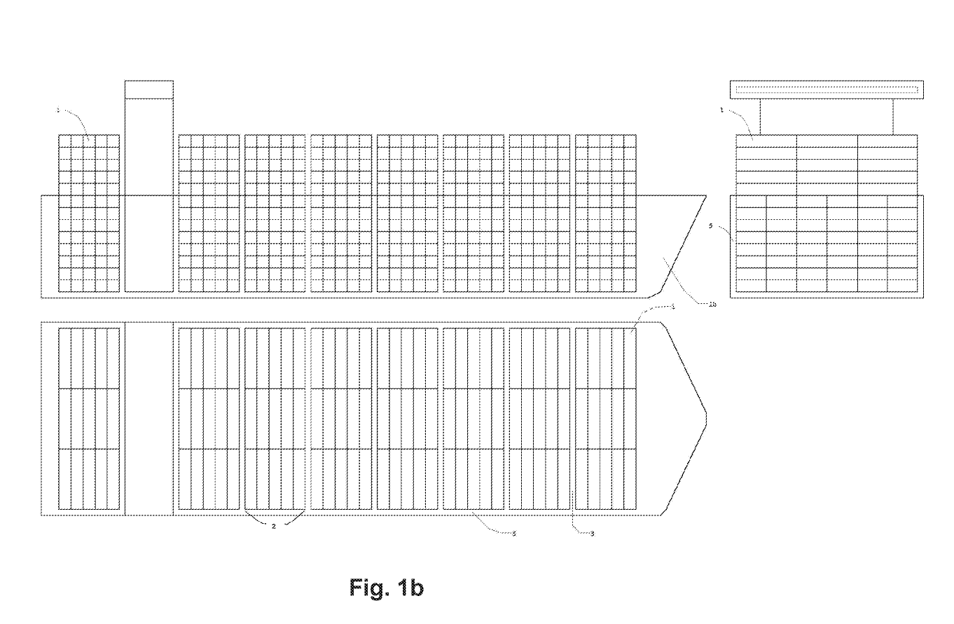

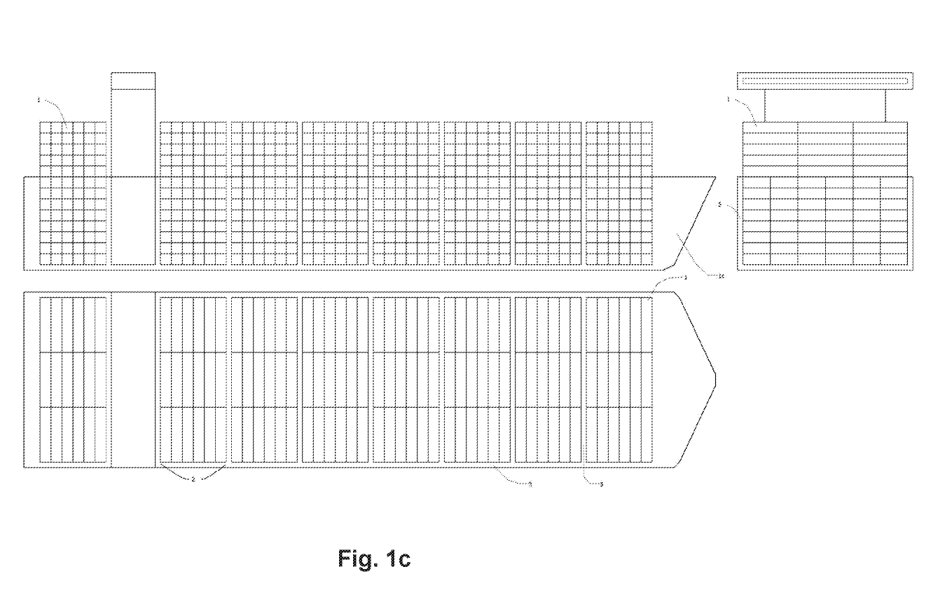

In FIGS. 1a and 1b They show in plan, elevation and cross section the differences between the arrangement of standardized containers in a current container ship (1a), with arrangement of the standardized containers (1) with their longitudinal axes parallel to the longitudinal axis of the ship (arranged longitudinally), and a container ship (1b), according to the first invention related to the method, with arrangement of the standardized containers (1) with their longitudinal axes orthogonal to the longitudinal axis of the ship (arranged transversely). The number of rows of standardized containers (1) arranged transversely in each bay (2) is variable; in FIG. 1b, the container ship (1b) has bays (2) of 5 rows of containers. As an example of other arrangements, in FIG. 1c a container ship (1c) that has bays (2) of 6 rows is shown.

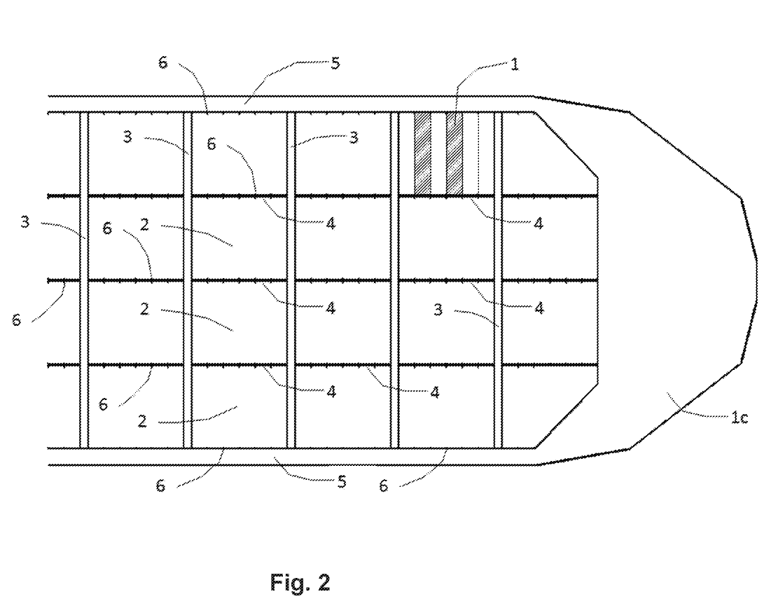

In FIG. 2 it is shown in plan a detail of the prow and of the front adjacent area of a container ship (1c), with bays (2) of 6 rows, where are observed the sides of the hull (5) and the transverse bulkheads (3); these transverse bulkheads (3) are separated by a distance so that between them fit a whole number of standardized containers (1) with their longitudinal axes parallel to said transverse bulkheads (3); likewise, they are observed in FIG. 2 the secondary longitudinal bulkheads (4) with which they are subdivided the holds (2) formed by the transverse bulkheads and the sides of the hull (5); these secondary longitudinal bulkheads (4) are separated with each other by a distance so that between them fits a standardized container (1) with its longitudinal axis orthogonal to said secondary longitudinal bulkheads (4). On the inside of the sides of the hull (5) and on both sides of the secondary longitudinal bulkheads (4) vertical guides (6) are mounted that facilitate the positioning and allow to arrange the standardized containers (1) stacked and with their longitudinal axes perpendicular to the longitudinal axis of the ship.

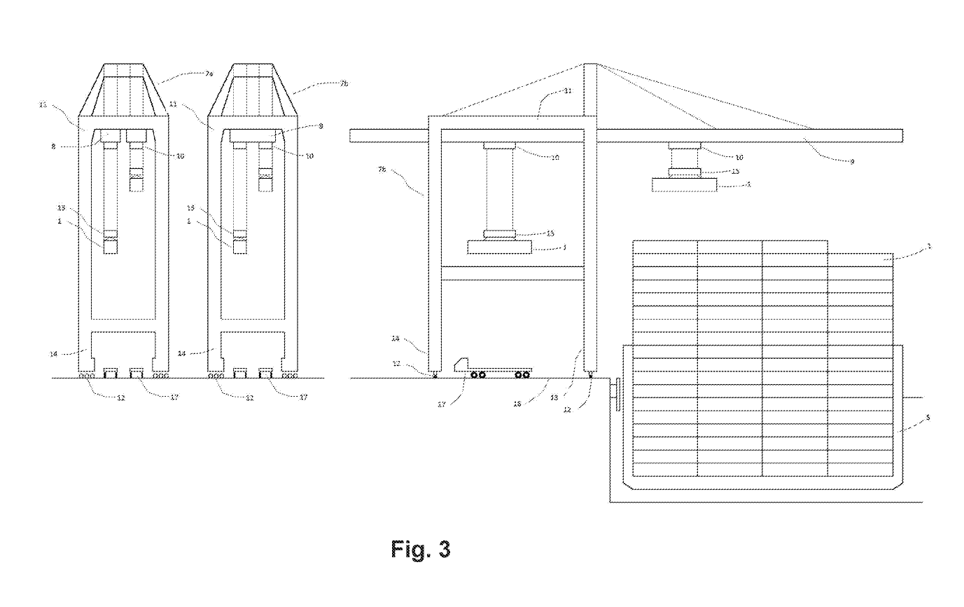

In FIG. 3 they are shown the longitudinal and transversal elevations of the harbor crane such as a gantry crane, according to the second invention related to the method, with which the transfer method of standardized containers will be presented. Specifically, in the longitudinal elevation it is shown a harbor crane in a first version (7a) of two independent jibs (8) with a carriage (10) each and in a second version (7b) of single jib (9) with two independent carriages (10). This harbor crane such as a gantry crane in the first version (7a) consists of a frame (11) that is supported by four legs with sets of support and rolling on rail (12) wheels, two front legs (13) on a front rail and two rear legs (14) on a rear rail, allowing the movement along the quay; said frame (11) has a gap between each pair of legs of the same rail such that it allows the placement of two independent jibs (8) perpendicular to the quay, supported by the upper part of the frame (11) and located in the gap formed between each pair of front legs (13) and rear ones (14); these independent jibs (8) support each a carriage (10) that moves longitudinally under it forward and backward and from which hangs in turn by means of cables a container clamping mechanism (spreader) (15) equipped with vertical movement, according to needs, thanks to lifting and lowering means located on the carriage (10); the spreader (15) is arranged such that its longitudinal axis coincides with the longitudinal axis of the independent jib (8), in this way the standardized containers (1) are loaded, moved and unloaded with the longitudinal axes thereof perpendicular to the edge of the quay at all times. In the second version (7b) the two independent jibs (8) are replaced by a single jib (9) perpendicular to the quay, supported by the upper part of the frame (11) and located in the gap formed between each pair of front legs (13) and rear ones (14); this single jib (9) has a suitable width to allow the support of two independent with each other carriages (10) and which move longitudinally under it forward and backward.

In the transverse elevation of FIG. 3, valid for the two versions (7a) and (7b), it is observed that the carriages (10), independent with each other, are in a certain position along the independent jib (8) of each or the single jib (9) of both, always according to version, and that the spreaders (15), each with a standardized container (1) with its longitudinal axis orthogonal to the edge of the quay, are at different heights.

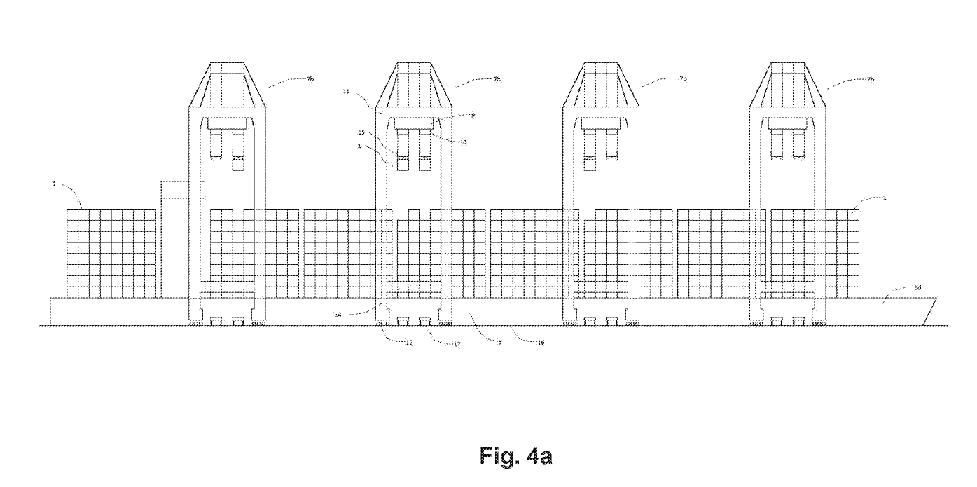

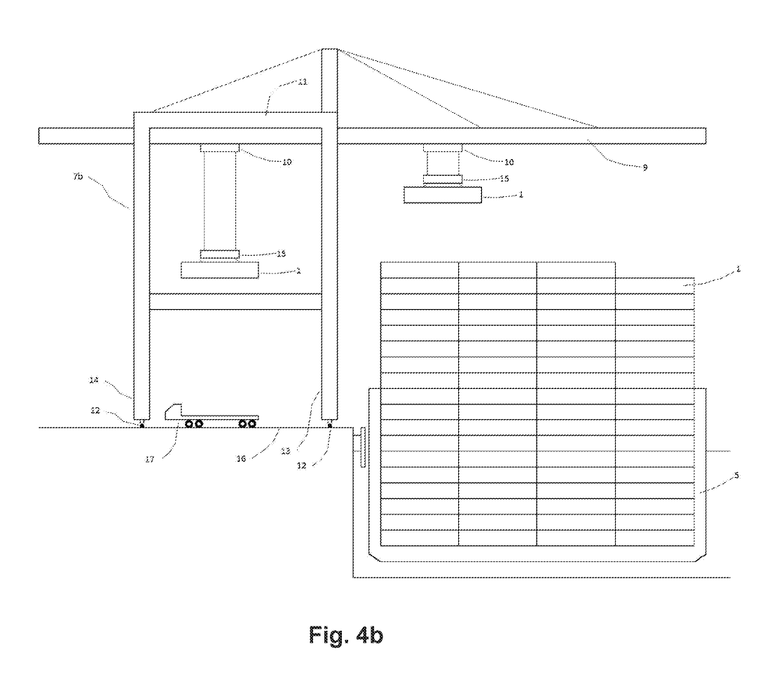

In FIGS. 4a and 4b they are shown, respectively, longitudinal and transversal elevations of the set quay (16), container ship (1d) with bays (2) of 8 rows and harbor cranes such as a gantry crane (7b) of single jib (9) with two independent carriages (10); based on these elevations an embodiment of the loading/unloading method of standardized containers (1) is presented below:

Unloading of standardized containers (1) from a container ship (1d) to the quay (16) that comprises the following steps:
Berthing of container ship (1d) with transversal arrangement of the standardized containers (1) inside and outside the holds and with bays (2) of 8 rows.
Positioning on the edge of the quay (16) of harbor crane such as a gantry crane (7b) of single jib (9) with two independent carriages (10) and each capable of maneuvering these standardized containers (1) by means of a spreader (15) whose longitudinal axis coincide in direction with the longitudinal axis of the standardized containers (1) (both axes orthogonal to the quay (16)).
Forward movement of the carriage (10) under the jib (9) of the crane (7b), with the spreader (15) elevated, until being positioned on the standardized container (1) to be moved located on the container ship (1d).
With the lifting and lowering means located on the carriage (10), maneuver of descent of the spreader (15) until it is fixed and secured to the standardized container (1).
Maneuver of ascent of the spreader (15)—standardized container (1) set and subsequent backwards movement of the carriage (10) under the jib (9), passing between the front legs (13) of the crane (7b), until being positioned on the means of transport (17) previously located under the crane (7b) in orthogonal position to the quay (16).
With the lifting and lowering means located on the carriage (10), maneuver of descent of the spreader (15)—standardized container (1) set until having the standardized container (1) resting on the means of transport (17) and fixed on the same; disconnection of the spreader (15) fixings on the standardized container (1).
Maneuver of ascent of the empty spreader (15) and forward movement of the carriage (10) under the jib (9) passing between the front legs (13) of the crane (7b) until it is positioned, with the spreader (15) elevated, on a new standardized container (1) to be transferred, located in the container ship (1d), to start the cycle again.

Loading of standardized containers (1) from the quay (16) to a container ship (1a) that comprises the following steps:
Berthing of container ship (1d) with transversal arrangement of the standardized containers (1) inside and outside the holds and with bays (2) of 8 rows.
Positioning on the edge of the quay (16) of harbor crane such as a gantry crane (7b) of single jib (9) with two independent carriages (10) and each capable of maneuvering these standardized containers (1) by means of a spreader (15) whose longitudinal axis coincide in direction with the longitudinal axis of the standardized containers (1) (both axes orthogonal to the quay (16)).
Positioning on the edge of the quay (16), under the crane (7b) and in position orthogonal to the quay of the means of transport (17) loaded with the standardized container (1) to be loaded in the container ship (1d).
Movement of the carriage (10) under the jib (9) of the crane (7b) until it is positioned, with the spreader (15) elevated, on the means of transport (17)—standardized container (1) set.
With the lifting and lowering means located on the carriage (10), maneuver of descent of the spreader (15) until it is fixed and secured to the standardized container (1); release of the fixings of the standardized container (1) with the means of transport (17).
Maneuver of ascent of the spreader (15)—standardized container (1) set and subsequent forward movement of the carriage (10) under the jib (9), passing between the front legs (13) of the crane (7b), until being positioned on the corresponding cell in the container ship (1d).
With the located on the carriage (10) lifting and lowering means, maneuver of descent of the spreader (15)—standardized container (1) set using the vertical guides (6) of the container ship (1d) until leaving the standardized container (1) in its final position, now on another standardized container (1) already placed, already on the bottom of the hold; subsequent disconnection of the spreader (15) fixings on the standardized container (1) and fastening of the standardized container (1) in the container ship (1d) with stowage elements.
Maneuver of ascent of the empty spreader (15) and subsequent backwards movement of the carriage (10) under the jib (9), passing between the front legs (13) of the crane (7b) until it is positioned, with the spreader (15) elevated, on a new means of transport (17)—standardized container (1) set to start the cycle again.

In the configuration of the embodiment of the loading/unloading method of standardized containers (1) shown in FIGS. 4a and 4b it is observed how the current gap between legs on the same rail (13) (14) has been adjusted in such a way that the movement of the crane (7b) along the quay (16) is minimized in the operations of loading and unloading; specifically in this case, the necessary clearances between standardized container (1)—standardized container (1) have been adjusted so that the crane (7b) can operate in each bay (2) of the container ship (1d) with the minimum movements along the edge of the quay (16); it is observed that, when the bays (2) have eight rows of standardized containers (1) each, a crane (7b) can operate with the 1^{st} and 3^{rd} rows to pass later to the 2^{nd} and 4^{th}, later 5^{th} and 7^{th} and, finally 6^{th} and 8^{th} rows with minimal movements as has been mentioned.

In addition, in FIGS. 4a and 4b it is supposed that each of the four harbor cranes such as a gantry crane (7b) that belong to it serve two bays (2) of 8 rows of standardized containers (1) each; nevertheless, it is observed in said FIG. 4a that twice as many harbor cranes such as a gantry crane (7b) (eight) fit perfectly by which each of them would serve a single bay (2), doubling the loading/unloading performance for that container ship (1d).

The loading/unloading of standardized containers (1) performance for the shown in FIGS. 4a and 4b arrangement is significantly greater than if current gantry cranes were used with container ships (1a) with longitudinal arrangement of the containers and of equal number of TEUs. This is because, for the same length and number of TEUs, a larger number of cranes can be arranged each operating with twice as many containers as a current gantry crane.

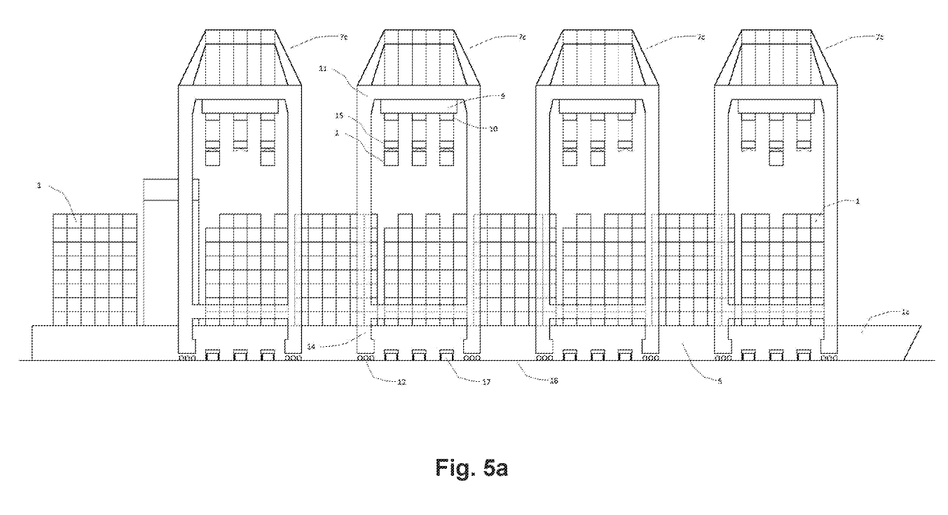

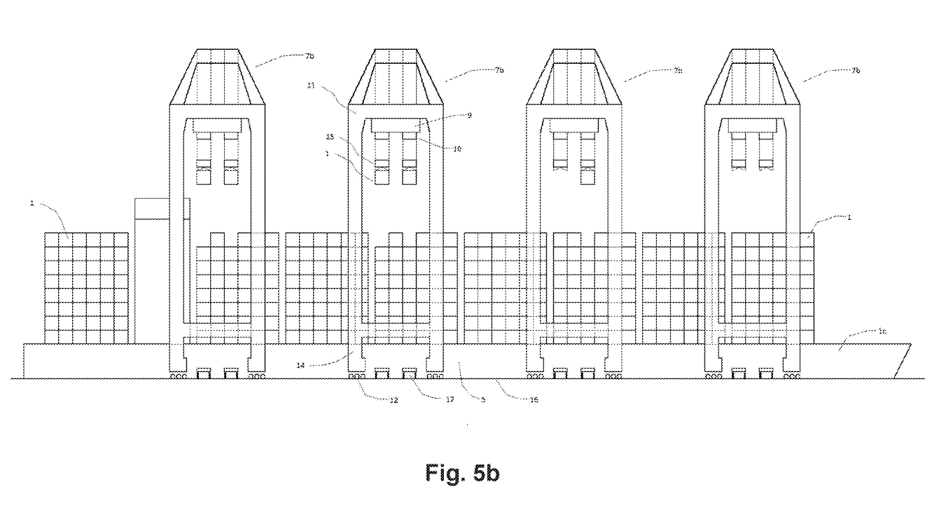

In FIGS. 5a and 5b they are shown, respectively, longitudinal elevations of two other embodiments of the method of unloading/loading of standardized containers (1); one of a container ship with bays of 6 rows and harbor cranes such as a gantry crane of single jib with three independent carriages and another of a container ship with bays of 6 rows and harbor cranes such as a gantry crane of single jib with two independent carriages.

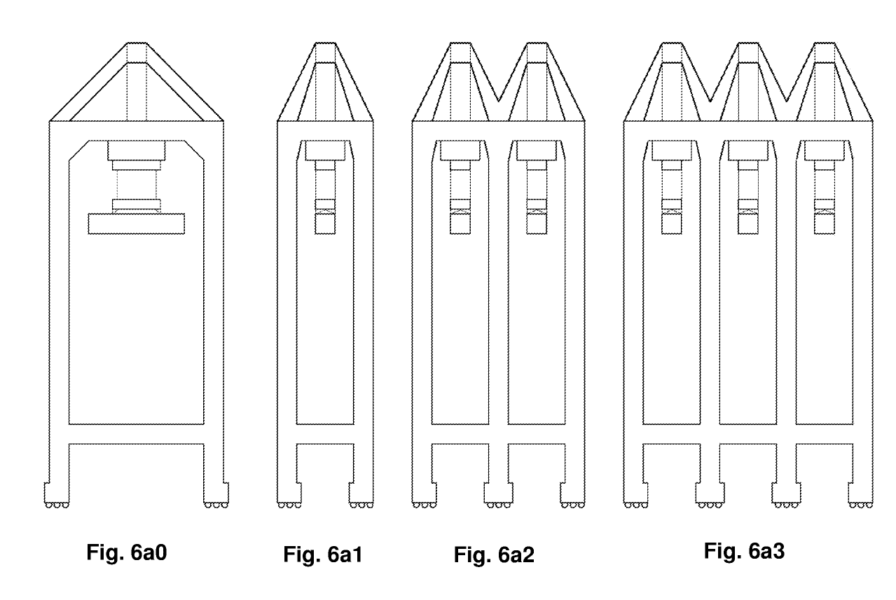

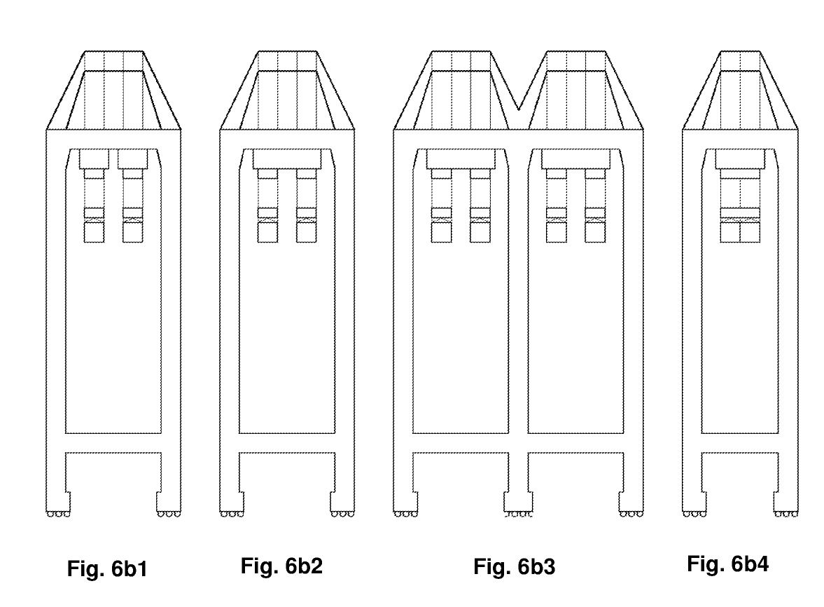

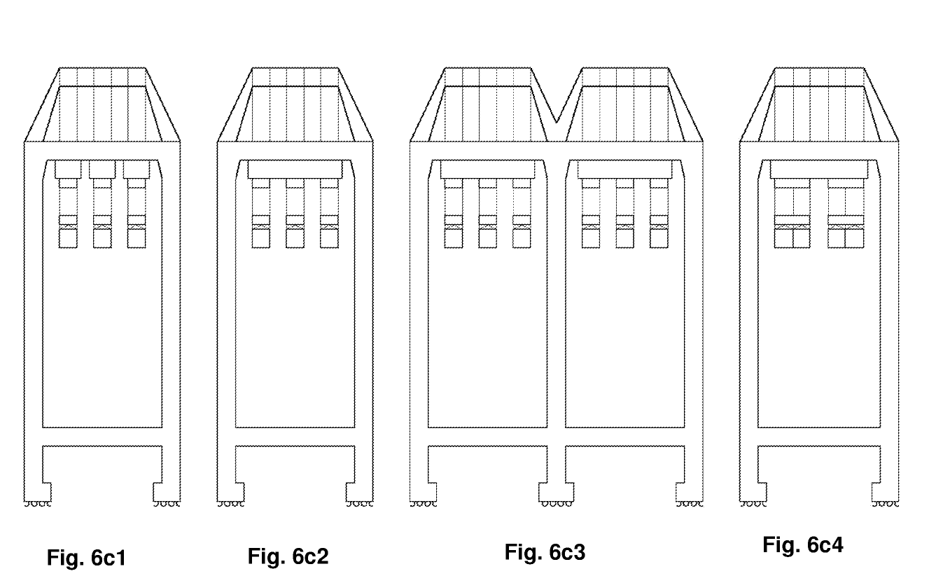

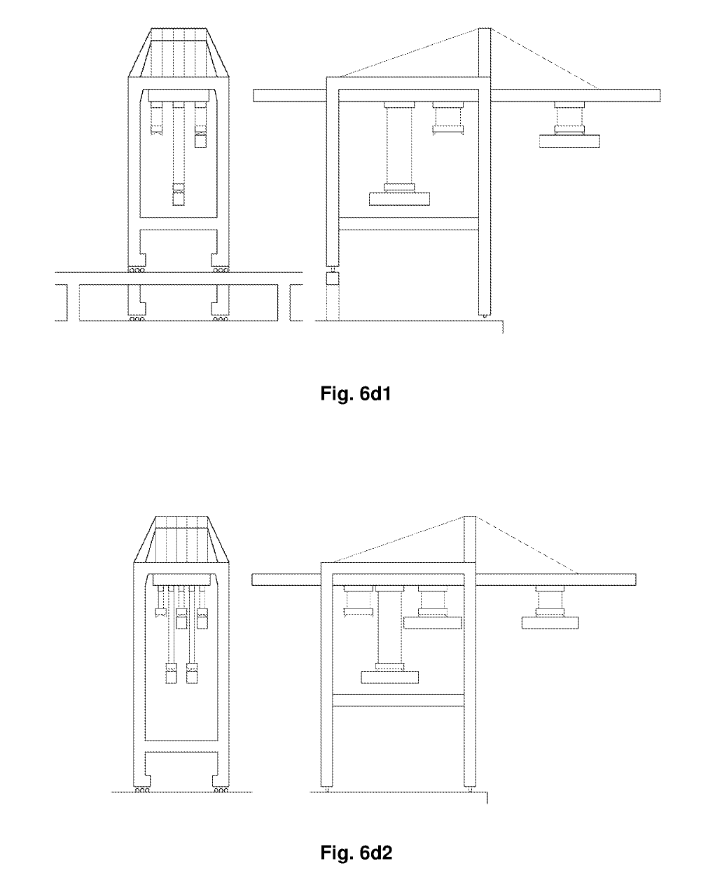

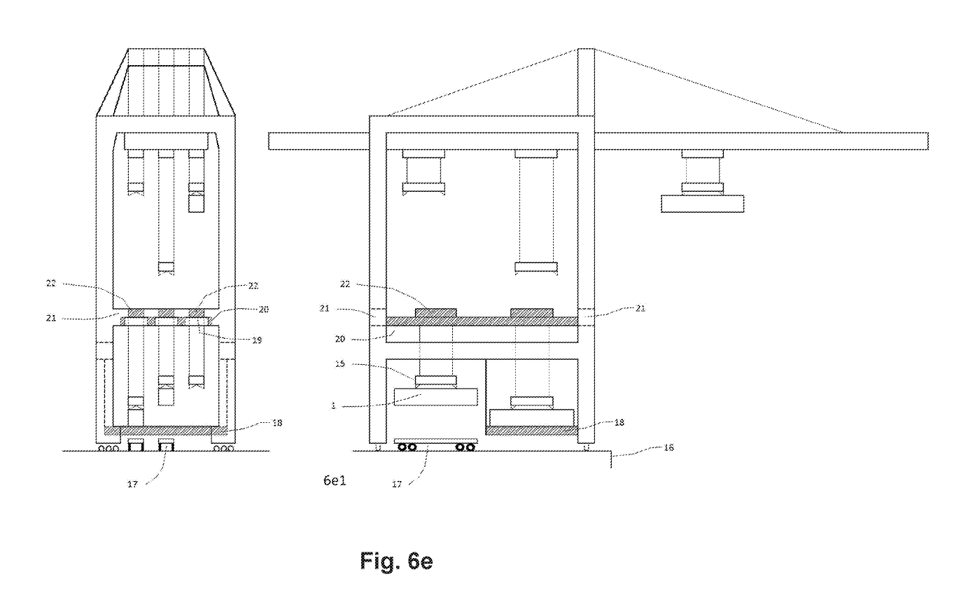

In FIGS. 6a, 6b, 6c, 6d and 6e they are shown longitudinal elevations of some (not all) of the different embodiments of harbor cranes such as a gantry crane according to the second invention related to the method and with which the same can be performed:

individual crane of an independent jib (6a1), composition of two individual cranes of an independent jib (6a2), composition of three individual cranes of an independent jib (6a3), individual crane of two independent jibs (6b1), individual crane of a jib with two independent carriages (6b2), composition of two individual cranes of a jib with two independent carriages (6b3), individual crane of an independent jib with a carriage of adequate dimensions to maneuver a double spreader (6b4), individual crane of three independent jibs (6c1), individual crane of a jib with three independent carriages (6c2), composition of two individual cranes of a jib with three independent carriages (6c3), individual crane of a jib with two independent carriages of adequate dimensions to maneuver each a double spreader (6c4), individual crane with rear legs on loading beam (6d1), individual crane in which the gaps between container—container are non-existent (6d2) and individual crane with lower frame under it and lower carriages (6e1). In FIG. 6a it is shown, in addition, a current harbor crane such as a gantry crane (6a0) to serve as a contrast.

1-22. (canceled)

23. A container ship comprising:
all or part of a plurality standardized containers of a container ship arranged transversely with their longitudinal axes perpendicular to a longitudinal axis of the ship, both in holds of the ship and in an outer area on said holds;
for this the holds where they are stored are formed by transverse bulkheads orthogonal to the longitudinal axis of the ship, transverse bulkheads that can contribute to the structural resistance of said ship and with a separation between these transverse bulkheads to allow placement of a whole number of standardized containers arranged transversely;
wherein each one of the holds between transverse bulkheads in turn is subdivided by secondary longitudinal bulkheads separated from each other by a length of a standardized container plus necessary clearances, and wherein on both sides of the secondary longitudinal bulkheads and on an inside of the sides of a hull, sides that close the hold, vertical guides are installed so as to allow for placement of the standardized containers as stacked and with their longitudinal axis perpendicular to the longitudinal axis of the ship.

24. The container ship according to claim 23, wherein all or part of the holds formed by the existing transverse bulkheads are subdivided by secondary longitudinal bulkheads separated from each other by the length of a standardized container and the necessary clearances;
and, further comprising disassembly of the vertical guides that exist in the transverse bulkheads and by the installation of vertical guides on both sides of the new secondary longitudinal bulkheads and on the inside of the sides of the hull so that standardized containers can be arranged in the thus formed cells with their longitudinal axis perpendicular to the longitudinal axis of the ship.

25. The container ship according to claim 23, wherein the vertical guides are extended outside the holds and above them, because said vertical guides are installed on longitudinal frames of suitable rigidity in vertical extension of the secondary longitudinal bulkheads and of the sides of the hull and in that with the help of closing transverse frames of suitable rigidity in vertical extension of the transverse bulkheads constitute a cellular structure, exterior to the holds, where standardized containers can be arranged in the thus formed cells with the same arrangement as those located in said holds with their longitudinal axes perpendicular to the longitudinal axis of the ship, and in an existing container ship with transverse frames, these transverse frames are adapted to the new arrangement of standardized containers by disassembling the vertical guides installed in them.

26. The container ship according to claim 23, wherein for the stowage of the standardized containers, already in all or in part of the loading areas of the ship, vertical guides are not used but, in those areas without vertical guides, the stowage is done by the lashing of the standardized containers.

27. Adaptation according to claim 23 of merchant ships in general wherein all or part of their holds and/or of the outer areas on them are adjusted for the stowage of standardized containers arranged transversely, with their longitudinal axes perpendicular to the longitudinal axis of the ship.

28. Gantry-type port crane for loading and unloading of standardized containers comprising:
a port crane supported by four legs with rolling mechanisms comprising sets of support wheels, two front legs on a front rail and two rear legs on a rear rail, allowing movement along a quay,
the port crane that in turn has a jib perpendicular to the quay located in an opening formed between the legs and supported by a gantry,
the jib that supports a carriage that moves longitudinally under it and from which hangs in turn by means of cables a container clamping mechanism called a spreader that provides for vertical movement, via lifting and lowering means located on the carriage,
wherein the spreader is arranged so that its longitudinal axis coincides with the longitudinal axis of the jib so that the standardized containers are loaded and unloaded with their longitudinal axis perpendicular to the edge of the quay which allows that the existing separation between legs on the same rail can be reduced adjusting it in such a way that, without endangering the stability of the port crane, is at least the width of a standardized container plus the necessary clearances between standardized container and legs, allowing the passage between the legs of a standardized container breadthwise.

29. Gantry-type port crane according to claim 28, wherein a frame of the crane is formed from two individual frames, and is supported by six legs with rolling mechanisms (sets of support wheels), three front legs on a front rail and three rear legs on a rear rail, allowing the movement along the quay,
and in that it has a total width such that it allows the placement of two independent jibs perpendicular to the quay, supported by the gantry and located in the two openings formed between the legs, independent jibs that each support a carriage that moves longitudinally under it and from which hangs in turn by means of cables the spreader equipped with vertical movement, and via lifting and lowering means located on the carriage, the spreader is arranged such that its longitudinal axis coincides with the longitudinal axis of the independent jib so that the standardized containers are loaded and unloaded with their longitudinal axis perpendicular to the edge of the quay,
which allows that the existing separation between each pair of legs on the same rail can be reduced adjusting it in such way that, without endangering the stability of the port crane and optimizing as much as possible that adjustment with regard to minimize the movement of the crane along the quay in the operations of loading and unloading, allows the passage between each pair of legs of the width of a standardized container (a standardized container breadthwise) with the necessary clearances between standardized container and legs.

30. Gantry-type port crane according to claim 28, wherein a frame of the crane is supported by four legs with rolling mechanisms (sets of support wheels), two front legs on a front rail and two rear legs on a rear rail, allowing the movement along the quay,
and in that said frame has a gap between legs of the same rail such that it allows the placement of two independent jibs perpendicular to the quay, supported by the gantry and located in the gap formed between the legs, independent jibs that each support a carriage that moves longitudinally under it and from which hangs in turn by means of cables the spreader equipped with vertical movement, and via lifting and lowering means located on the carriage, the spreader is arranged such that its longitudinal axis coincides with the longitudinal axis of the independent jib so that the standardized containers are loaded and unloaded with their longitudinal axis perpendicular to the edge of the quay,
which allows that the existing separation between legs on the same rail can be reduced adjusting it in such way that, without endangering the stability of the port crane and optimizing as much as possible that adjustment with regard to minimize the movement of the crane along the quay in the operations of loading and unloading, allows the passage between the legs of the width of two standardized containers (two standardized containers breadthwise) with the necessary clearances between standardized container—standardized container and between standardized container—leg.

31. Gantry-type port crane according to claim 28, wherein a frame of the crane is formed from three or more individual frames, in that it is supported by four or more pairs of legs with rolling mechanisms (sets of support wheels), four or more front legs on a front rail and four or more rear legs on a rear rail, allowing the movement along the quay,
and in that has a total width such that it allows the placement of three or more independent jibs perpendicular to the quay, supported by the gantry and located in the three or more openings formed between the legs, independent jibs that each support a carriage that moves longitudinally under it and from which hangs in turn by means of cables the spreader equipped with vertical movement and via lifting and lowering means located on the carriage, the spreader is arranged such that its longitudinal axis coincides with the longitudinal axis of the independent jib so that the standardized containers are loaded and unloaded with their longitudinal axis perpendicular to the edge of the quay,
which allows that the existing separation between each pair of legs on the same rail can be reduced adjusting it in such a way that, without endangering the stability of the port crane and optimizing as much as possible that adjustment with regard to minimize the movement of the crane along the quay in the operations of loading and unloading, allows the passage between each pair of legs of the width of a standardized container (a standardized container breadthwise) with the necessary clearances between standardized container and legs.

32. Gantry-type port crane according to claim 28, wherein a frame of the crane is supported by four legs with rolling mechanisms (sets of support wheels), two front legs on a front rail and two rear legs on a rear rail, allowing the movement along the quay,
and in that said frame has a gap between legs of the same rail such that it allows the placement of three or more independent jibs perpendicular to the quay, supported by the gantry and located in the gap formed between the legs, independent jibs that each support a carriage that moves longitudinally under it and from which hangs in turn by means of cables the spreader equipped with vertical movement, and via lifting and lowering means located on the carriage, spreader arranged such that its longitudinal axis coincides with the longitudinal axis of the independent jib so that the standardized containers are loaded and unloaded with their longitudinal axis perpendicular to the edge of the quay,
which allows that the existing separation between legs on the same rail can be reduced adjusting it in such way that, without endangering the stability of the port crane and optimizing as much as possible that adjustment with regard to minimize the movement of the crane along the quay in the operations of loading and unloading, allows the passage between the legs of the width of three or more standardized containers (three or more standardized containers breadthwise) with the necessary clearances between standardized container—standardized container and between the standardized container—leg.

33. Gantry-type port crane according to claim 30, wherein the two independent jibs are replaced by a single jib perpendicular to the quay, supported by the gantry and located in the opening formed between the legs, single jib of a suitable width to allow the support of two independent with each other carriages and which move longitudinally under it;
from each one of the carriages hangs in turn by means of cables the spreader equipped with vertical movement, and, via lifting and lowering means located on the carriage, the spreader is arranged such that its longitudinal axis coincides with the longitudinal axis of the single jib so that the standardized containers are loaded and unloaded with their longitudinal axis perpendicular to the edge of the quay,
which allows that the existing separation between legs on the same rail can be reduced adjusting it in such way that, without endangering the stability of the port crane and optimizing that adjustment with regard to minimize as much as possible the movement of the crane along the quay in the operations of loading and unloading, allows the passage between the legs of the width of two standardized containers (two standardized containers breadthwise) with the necessary clearances between standardized container and standardized container and between standardized container leg.

34. Gantry-type port crane according to claim 32, wherein the three or more independent jibs are replaced by a single jib or a smaller number of jobs perpendicular to the quay, supported by the gantry and located in the gap formed between the legs, jib/s of a suitable width to allow the support of two, three or more independent with each other carriages and which move longitudinally under them;
from each one of the carriages hangs in turn by means of cables the spreader equipped with vertical movement, and, via lifting and lowering means located on the carriage, the spreader is arranged such that its longitudinal axis coincides with the longitudinal axis of the jib so that the standardized containers are loaded and unloaded with their longitudinal axis perpendicular to the edge of the quay,
which allows that the existing separation between legs on the same rail can be reduced adjusting it in such way that, without endangering the stability of the port crane and optimizing as much as possible that adjustment with regard to minimize the movement of the crane along the quay in the operations of loading and unloading, allows the passage between the legs of the width of three or more standardized containers (three or more standardized containers breadthwise) with the necessary clearances between the standardized container and standardized container and between standardized container leg.

35. Gantry-type port crane of claim 30, wherein the crane is formed from two or more port cranes, the set being supported by three or more pairs of legs with rolling mechanisms (sets of support wheels), three or more front legs on a front rail and three or more rear legs on a rear rail, allowing the movement along the quay,
and in that has a total width such that it allows the movement of two or more pairs of independent jibs, jibs all perpendicular to the quay, supported by the gantry and located in the two or more openings formed between the legs, jibs that support carriages that move longitudinally under them and from each one of them hangs in turn by means of cables the spreader equipped with vertical movement, and, via lifting and lowering means located on the carriage, spreader arranged such that its longitudinal axis coincides with the longitudinal axis of the jibs so that the standardized containers are loaded and unloaded with their longitudinal axis perpendicular to the edge of the quay,
which allows that the existing separation between each pair of legs on the same rail can be reduced adjusting it in such way that, without endangering the stability of the port crane and optimizing as much as possible that adjustment with regard to minimize the movement of the crane along the quay in the operations of loading and unloading, allows the passage between each pair of legs of the width of two standardized containers (two standardized containers breadthwise) with the necessary clearances, between standardized container—standardized container and between standardized container—leg.

36. Gantry-type port crane of claim 32, wherein the crane is formed from two or more cranes, the set being supported by three or more pairs of legs with rolling mechanisms (sets of support wheels), three or more front legs on a front rail and three or more rear legs on a rear rail, allowing the movement along the quay,
and in that has a total width such that it allows the placement of two or more groups of three or more independent jibs each, the jibs all perpendicular to the quay, supported by the gantry and located in the two or more openings formed between the legs, jibs that support carriages that move longitudinally under them and from each one of them hangs in turn by means of cables the spreader equipped with vertical movement, and, via lifting and lowering means located on the carriage, the spreader is arranged such that its longitudinal axis coincides with the longitudinal axis of the jib so that the standardized containers are loaded and unloaded with their longitudinal axis perpendicular to the edge of the quay,
which allows that the existing separation between each pair of legs on the same rail can be reduced adjusting it in such way that, without endangering the stability of the port crane and optimizing as much as possible that adjustment with regard to minimize the movement of the crane along the quay in the operations of loading and unloading, allows the passage between each pair of legs of the width of three or more standardized containers (three or more standardized containers breadthwise) with the necessary clearances between standardized container—standardized container and between standardized container—leg.

37. Gantry-type port crane according to claim 30, wherein the gaps between standardized container—standardized container are non-existent, which allows operation with standardized containers adjacent in the ship provided that crossing at a level between them is avoided, both vertically and horizontally, during the loading-unloading operations.

38. Gantry-type port crane according to claim 28, wherein the rear rail on which the rear legs of the crane are supported is arranged, along the quay, on an elevated loading beam over the working area, supported on pillars of a sufficient height that allows the passage of the transport means of standardized containers under it and with a spacing between said pillars such that is considerably greater than the distance between rear legs of the crane, achieving in this way a more clear crossing area and facilitating, therefore, the maneuver of moving the standardized containers from the operation area to the storage area and vice versa as well as the placement under the crane of said transport means; the rear legs of the cranes with their rolling mechanisms (sets of support wheels), when resting on that elevated rail, are shorter than the front legs.

39. Gantry-type port crane according to claim 28, wherein the jib with its corresponding carriage is adapted for the use of multiple spreaders capable to maneuver all at once two or more standardized containers contiguous in width (with the sides adjacent lengthways);
or for passage of a double spreader, this is identical in length to the simple spreaders but twice as wide; the longitudinal axis of this double spreader is, like that of the simple spreaders, coinciding with the longitudinal axis of the jib that supports the carriage that maneuvers it; wherein this disposition applies to the gantry-type port cranes, with one or several independent jibs or with one or several jibs with two or more independent carriages from each one of which hang double spreaders, always taking into account the necessary clearances, either for reasons of safety, logistics or of any other nature, between standardized containers of contiguous double spreaders and between standardized container—leg of the crane and optimizing as much as possible these clearances with regard to minimize the movement of the crane along the quay in the operations of loading and unloading.

40. Gantry-type port crane according to claim 28, wherein the standardized container is moved by the movement of the carriage and of the spreader from the ship to a lower frame, located under the crane and on which it is deposited;
this lower frame, that may or may not be attached to the port crane, is served by one or more, independent with each other and parallel to the quay, bridge cranes; these bridge cranes are on two supports on lower horizontal beams perpendicular to the quay, beams that are each connected at their ends to the two lower horizontal beams of the frame of the port crane that are parallel to the quay; these bridge cranes move orthogonally to the quay each with a lower carriage, attached to it, equipped with another spreader which in turn is coupled, by fixing it, to the standardized container located in the lower frame to move it and load it (or unload it in the inverse operation) in the means of transport of standardized containers.

41. Procedure for unloading of standardized containers from a container ship, or other type of ship, to a quay by gantry-type port cranes comprising the following steps:
Berthing of a container ship with transversal arrangement of standardized containers inside and outside the holds;
Positioning on an edge of a quay of a gantry-type port crane with a carriage or independent carriages with capacity to maneuver these standardized containers by means of a spreader whose longitudinal axis coincides in a direction with a longitudinal axis of the standardized containers (both axes orthogonal to the quay);
Forward movement of the carriage under a jib of a crane, with the spreader elevated, until being positioned on the standardized container to be moved located on the container ship;
With the lifting and lowering means located on the carriage, maneuvering a descent of the spreader until it is fixed and secured to the standardized container;
Maneuver an ascent of the spreader—standardized container set and subsequent backwards movement of the carriage under the jib, passing between legs of the crane, until being positioned on a means of transport previously located under the crane in an orthogonal position to the quay;
With the lifting and lowering means located on the carriage, maneuver a descent of the spreader—standardized container set until having the standardized container resting on the means of transport and fixed on the same, and disconnecting of the spreader fixings on the standardized container; and
Maneuver an ascent of the empty spreader and forward movement of the carriage under the jib of the crane, with the spreader elevated, until being positioned on a new standardized container to be transferred, located in the container ship, to start again the cycle.

42. Procedure for loading of standardized containers from a quay to a container ship, or to other type of ship, by way of gantry-type port cranes comprising the following steps:
Berthing of a container ship with a transversal arrangement of standardized containers inside and outside holds;
Positioning on an edge of a quay of a gantry-type port crane with a carriage or independent carriages with capacity to maneuver these standardized containers by a spreader whose longitudinal axis coincides in direction with the longitudinal axis of the standardized containers (both axes orthogonal to the quay);
Positioning on the edge of the quay, under the crane and in orthogonal position to the quay of a means of transport with the standardized container to be loaded in the container ship;
Movement of a carriage under a jib of the crane until it is positioned, with the spreader elevated, on the means of transport—standardized container set;
With a lifting and lowering means located on the carriage, maneuver of a descent of the spreader until it is fixed and secured to the standardized container; releasing of fixings of the standardized container with the means of transport;
Maneuver of an ascent of the spreader—standardized container set and subsequent forward movement of the carriage under the jib, passing between legs of the crane, until being positioned on a corresponding cell in the container ship;
With the lifting and lowering means located on the carriage, maneuver of descent of the spreader—standardized container set using vertical guides of the container ship until leaving the standardized container in its final position, now on another standardized container already placed, already on the bottom of the hold; subsequently disconnecting of the spreader fixings on the standardized container and fixing of the standardized container in the container ship with stowage elements; and
Maneuver of an ascent of the empty spreader and subsequent backwards movement of the carriage under the jib, passing between the legs of the crane, until it is positioned, with the spreader elevated, on a new means of transport—standardized container set to start again the cycle.

43. Procedure for loading and unloading of standardized containers according to claim 41 by means of gantry-type port cranes, wherein different steps are conducted with the use of a multiple spreader for maneuvering two or more standardized containers all at once (standardized containers with long sides adjacent) and in that the means of transport to be positioned under the crane must have adequate dimensions to be able to move two or more standardized containers all at once, according to the number of standardized containers the spreader is capable to maneuver.

44. Procedure for loading and unloading of standardized containers according to claim 41 by means of gantry-type port cranes, wherein an intermediate step exists by which the standardized container/s is/are unloaded on a lower frame (or loaded from that lower frame, in the inverse operation) located under the crane, instead of being directly unloaded on the means of transport (or loaded from that means of transport, in the inverse operation); this lower frame, that may or may not be attached to the port crane, is served by one or more independent between them and parallel to the quay bridge cranes;
these bridge cranes are on two supports on lower horizontal beams perpendicular to the quay, lower horizontal beams that are united each by their ends to the two lower horizontal beams of the frame of the port crane that are parallel to the quay; these bridge cranes move orthogonally to the quay along the lower horizontal beams and each has a lower carriage, attached to it, equipped with another spreader, simple or multiple, which in turn is coupled, by fixing it, to the standardized container/s located in the lower frame to transfer it/them and load it/them (or unload it/them in the inverse operation) in the means of transport of standardized containers; with this the typical cycle of the gantry-type port crane is simplified.
